(19) United States
(12) Patent Application Publication
(10) Pub. No.: US 2025/0284109 A1
(43) Pub. Date: Sep. 11, 2025

(54) OPTICAL SYSTEM, OPTICAL APPARATUS, AND IMAGE PICKUP APPARATUS

(71) Applicant: CANON KABUSHIKI KAISHA, Tokyo (JP)

(72) Inventor: Hiroto KANO, Tochigi (JP)

(21) Appl. No.: 19/043,956

(22) Filed: Feb. 3, 2025

(30) Foreign Application Priority Data
Mar. 11, 2024 (JP) 2024-037386

(51) Int. Cl. G02B 23/02

(52) U.S. Cl. CPC G02B 23/02

(57) ABSTRACT

An optical system includes a first front group and a second front group that are arranged in a first direction perpendicular to an optical axis direction, a rear group that is commonly used for the first front group and the second front group, a first aperture stop disposed between the first front group and the rear group, and a second aperture stop disposed between the second front group and the rear group. A first principal ray passing through an aperture center in the first aperture stop and a second principal ray passing through an aperture center in the second aperture stop are guided to an intersection of an optical axis of the rear group and an image plane.

### BACKGROUND

### Technical Field

The present disclosure relates generally to an optical system, and more particularly to an optical system suitable for an image pickup apparatus, such as a digital video camera, a digital still camera, a broadcasting camera, a film-based camera, and a surveillance camera.

### Description of Related Art

An image pickup apparatus has recently been demanded to provide stereoscopic imaging in order to capture a video for use in content that provides immersion, such as virtual reality. In particular, a stereoscopic video capture apparatus has been demanded to capture images from two viewpoints with parallax close to that of a human.

Japanese Patent No. 6280803 discloses a configuration that includes front groups arranged in parallel, a common rear group, and an aperture stop disposed on the rear group side of each front group, and can acquire a parallax image in single imaging.

### SUMMARY

An optical system according to one aspect of the disclosure includes a first front group and a second front group that are arranged in a first direction perpendicular to an optical axis direction, a rear group that is commonly used for the first front group and the second front group, a first aperture stop disposed between the first front group and the rear group, and a second aperture stop disposed between the second front group and the rear group. A first principal ray passing through an aperture center in the first aperture stop and a second principal ray passing through an aperture center in the second aperture stop are guided to an intersection of an optical axis of the rear group and an image plane. The following inequalities may be satisfied:

$$0.06 \leq \vert Sh 1 / fb \vert \leq 0.5 \\ 0.06 \leq \vert Sh 2 / fb \vert \leq 0.5$$

where Sh1 is a distance in the first direction between the first principal ray just before entering the rear group and the optical axis of the rear group in an in-focus state at infinity, Sh2 is a distance in the first direction between the second principal ray just before entering the rear group and the optical axis of the rear group in the in-focus state at infinity, and fb is a focal length of the rear group in the in-focus state at infinity.

An optical apparatus according to another aspect of the disclosure is detachably mountable to an image pickup apparatus. The optical apparatus includes the above optical system, a communication unit communicable with the image pickup apparatus. The image pickup apparatus includes a first photoelectric converter and a second photoelectric converter, each of which is configured to photoelectrically convert an image formed by light passing through the first aperture stop and the second aperture stop. The communication unit transmits to the image pickup apparatus information regarding the optical system that is used to correct signals from the first photoelectric converter and the second photoelectric converter.

An image pickup apparatus according to another aspect of the disclosure is detachably mounted with the above optical apparatus, and includes the first photoelectric converter, and the second photoelectric converter.

Further features of various embodiments of the disclosure will become apparent from the following description of embodiments with reference to the attached drawings.

### BRIEF DESCRIPTION OF THE DRAWINGS

FIG. 1 illustrates an optical system according to this embodiment.

FIG. 2 illustrates rays passing through the optical system according to this embodiment.

FIG. 3 illustrates a part of the optical system and an image sensor disposed on an image plane.

FIG. 4 illustrates a relationship between an output signal from a photoelectric converter and an incident angle.

FIG. 5 illustrates a variation of the optical system according to this embodiment.

FIG. 6 illustrates an optical system according to Example 1.

FIG. 7 illustrates a part of the optical system according to Example 1.

FIG. 8 illustrates a part of an optical system according to Example 2.

FIG. 9 illustrates a part of an optical system according to Example 3.

FIG. 10 illustrates image-plane position fluctuations in the optical system.

FIG. 11 illustrates an image pickup apparatus including the optical system according to this embodiment.

### DETAILED DESCRIPTION

Referring now to the accompanying drawings, a detailed description will be given of embodiments according to the disclosure. Corresponding elements in respective figures will be designated by the same reference numerals, and a duplicate description thereof will be omitted.

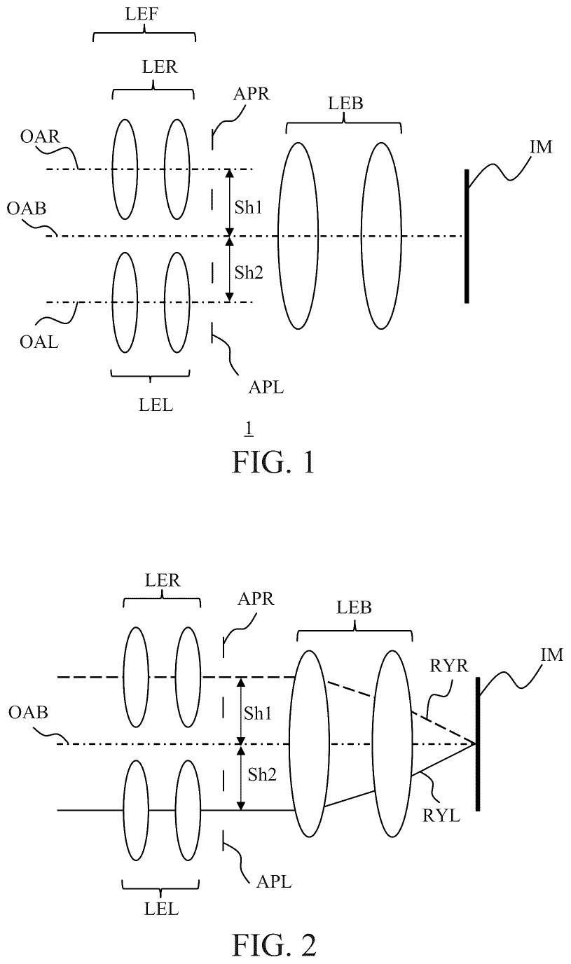

FIG. 1 illustrates an optical system 1 according to this embodiment. The optical system 1 includes, in order from an object side to an image side, a front group LEF, an aperture stop, and a rear group LEB. The front group LEF includes a first front group LER and a second front group LEL, each of which includes one or more optical elements. The first front group LER and the second front group LEL are arranged in a direction (first direction) perpendicular (or orthogonal) to a direction (optical axis direction) parallel to an optical axis OAB of the rear group LEB. In this embodiment, the first front group LER and the second front group LEL are optical systems having the same configuration. An aperture stop includes a first aperture stop APR and a second aperture stop APL. The first aperture stop APR and the second aperture stop APL are disposed adjacent to and on the object side of the rear group LEB. The rear group LEB includes one or more optical elements. An optical axis OAR of the first front group LER, an optical axis OAL of the second front group LEL, and an optical axis OAB of the rear group LEB are defined as axes passing through the surface vertices of the optical elements. In a case where a part of optical elements having refractive power is decentered to satisfactorily correct aberrations, an optical axis common to the largest number of optical elements is set as the optical axis of each group. IM represents an image plane of the optical system 1.

The rear group LEB may have positive refractive power. This configuration can increase angles of rays that pass through the first front group LER and the second front group LEL and enter the image sensor, and suppress the influence of crosstalk. The rear group LEB may have negative refractive power, but may have positive refractive power for the reasons described above.

The lenses closest to an object of the first front group LER and the second front group LEL may be negative lenses. This configuration can achieve stereoscopic imaging while reducing the size of the optical system.

A lens closest to an image plane of the optical system 1 may be a positive lens. This configuration can suppress angles of rays incident on the peripheral portion of the image sensor, and the influence of crosstalk.

The optical system 1 may include an optical element configured to move during focusing. The optical element may be provided in the front group LEF or the rear group LEB. In this case, a focus mechanism configured to move the optical element during focusing is provided in the image pickup apparatus body to which the optical system 1 is attached.

FIG. 2 illustrates rays passing through the optical system 1. A first ray RYR is a principal ray (first principal ray) that passes through the aperture center in the aperture stop among light that passes through the first front group LER and the rear group LEB and is condensed on the image plane IM. A second ray RYL is a principal ray (second principal ray) that passes through the aperture center in the aperture stop among light that passes through the second front group LEL and the rear group LEB and is condensed on the image plane IM. In an in-focus state (on an object) at infinity, the first ray RYR just before entering the rear group LEB passes through a position that is separated by a distance (width) Sh1 from the optical axis OAB in a direction perpendicular to the optical axis OAB. In the in-focus state at infinity, the second ray RYL just before entering the rear group LEB passes through a position that is separated by a distance (width) Sh2 from the optical axis OAB in a direction perpendicular to the optical axis OAB. The first ray RYR just before entering the rear group LEB, the second ray RYL just before entering the rear group LEB, and the optical axis OAB are parallel and non-coaxial with each other. The first ray RYR and the second ray RYL are guided to the intersection of the image plane IM and the optical axis OAB. This configuration can acquire a parallax image regardless of the position of the object surface of the optical system 1.

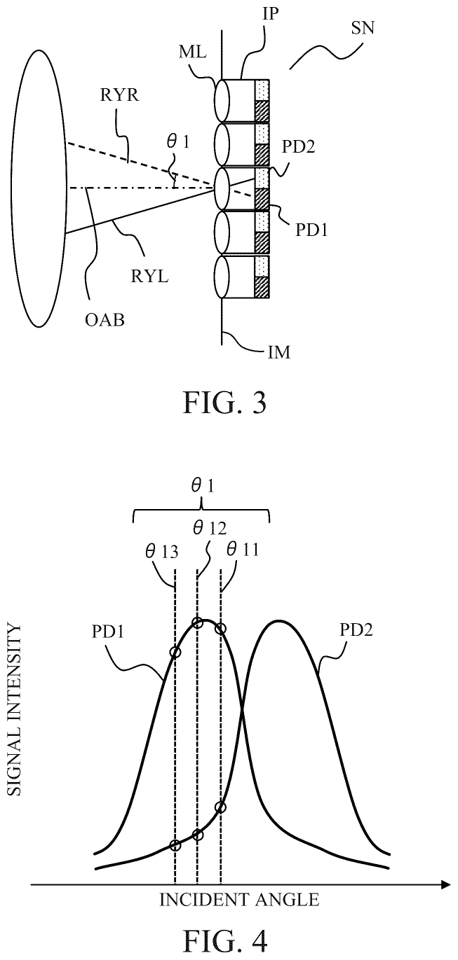

FIG. 3 illustrates a part of the optical system 1 and an image sensor SN disposed on the image plane IM. The image sensor SN has a plurality of pixels IP. Each pixel IP includes a microlens ML, a first photoelectric converter PD1, and a second photoelectric converter PD2. The arrangement direction of the first photoelectric converter PD1 and the second photoelectric converter PD2 and the arrangement direction of the first front group LER and the second front group LEL may be the same direction (parallel). FIG. 3 illustrates only the rays passing through the centers of the first photoelectric converter PD1 and the second photoelectric converter PD2 among the first rays RYR and the second rays RYL, and omits the other rays.

The optical system 1 condenses the first ray RYR and the second ray RYL on the same (common) microlens ML. At this time, the first ray RYR and the second ray RYL have passed through different pupils, and therefore enter the microlens ML at different incident angles. More specifically, one ray RYR is incident on the microlens ML from above and the other from below with respect to the normal indicated by an alternate long and short dash line of the imaging surface of the image sensor SN. That is, in this embodiment, the signs of the incident angles of the first ray RYR and the second ray RYL with respect to the microlens ML are different from each other. The absolute values of the incident angles of the first ray RYR and the second ray RYL with respect to the microlens ML may be different. The normal may be a cross section including the optical axis of the microlens ML.

The microlens ML condenses (introduces) the first ray RYR that has passed through the first aperture stop APR onto the first photoelectric converter PD1. The microlens ML also condenses (introduces) the second ray RYL that has passed through the second aperture stop APL onto the second photoelectric converter PD2. That is, the optical system 1 guides the first ray RYR that has passed through the microlens ML to the first photoelectric converter PD1, and guides the second ray RYL that has passed through the microlens ML to the second photoelectric converter PD2. Therefore, separating the signals from the photoelectric converter PD1 and the photoelectric converter PD2 can separate a signal based on the ray that has passed through the first front group LER and a signal based on the ray that has passed through the second front group LEL from each other.

The optical system 1 allows the first ray RYR guided by the first front group LER and the second ray RYL guided by the second front group LEL to pass through a common rear group LEB and condenses them on a single image sensor SN on the image plane IM. Thereby, the first ray RYR and the second ray RYL can be guided to the image sensor SN through the common rear group LEB, and simplifies the optical system 1.

The optical axis of the microlens ML disposed in the peripheral portion of the image sensor SN may be offset relative to the middle part between the first photoelectric converter PD1 and the second photoelectric converter PD2. The optical axis of the microlens ML may be decentered parallel to the center side relative to the middle part between the first photoelectric converter PD1 and the second photoelectric converter PD2. A decentering amount may be different for each area on the image sensor SN.

Here, a ray that enters the center of the microlens ML for an arbitrary pixel IP and is guided to a position between the first photoelectric converter PD1 and the second photoelectric converter PD2 for that pixel IP is defined as a reference ray for that pixel IP. The reference ray may be different for each position of the pixel IP in the image sensor SN. In this case, an incident angle of the reference ray incident on the microlens ML for a pixel IP located in the peripheral portion of the image sensor SN may be larger than (tilted relative to) an incident angle of the reference ray incident on the microlens ML for a pixel IP located in the center of the image sensor SN. The reference ray incident on the microlens ML located at the center of the image sensor SN may be parallel to the normal to the imaging surface of the image sensor SN.

Here, θ1 is an incident angle at which the first ray RYR is incident on the microlens ML. The incident angle θ1 is determined by a focal length of the rear group LEB and the width Sh1 between the first principal ray and the optical axis OAB. In other words, as the focal length of the rear group LEB reduces, or the wider the width Sh1 increases, the incident angle θ1 increases.

FIG. 4 illustrates the distribution (signal intensity distribution) of the signal intensity obtained by each photoelectric converter relative to the incident angle of the ray to the image sensor SN. In FIG. 4, a vertical axis represents a signal intensity corresponding to the light receiving sensitivity of the first photoelectric converter PD1 or the second photoelectric converter PD2. A horizontal axis represents an incident angle at which the first ray RYR and the second ray RYL are incident on the microlens ML. The horizontal axis value is normalized based on the intersection of the signal intensity distributions of the first photoelectric converter PD1 and the second photoelectric converter PD2. FIG. 4 illustrates signal intensities when the incident angle θ1 is θ11, θ12, and θ13. Normalization may be performed by associating the intersections of the signal intensity distributions of the first photoelectric converter PD1 and the second photoelectric converter PD2 with the incident angle of a reference ray to an arbitrary pixel as the reference.

In FIG. 4, the first photoelectric converter PD1 that photoelectrically converts the first ray RYR has signal intensity even at the incident angle on the photoelectric converter PD2 side due to the influence of crosstalk generated between adjacent photoelectric converters. Crosstalk also occurs in the second photoelectric converter PD2 similarly to the first photoelectric converter PD1. A crosstalk amount generated in the first photoelectric converter PD1 and a crosstalk amount generated in the second photoelectric converter PD2 are different depending on the incident angle on the image sensor SN (or the microlens ML). In a case where the incident angle approaches the intersection of the signal intensity distributions of the first photoelectric converter PD1 and the second photoelectric converter PD2, that is, in a case where the incident angle θ1 becomes θ11, the influence of crosstalk increases. Therefore, properly setting the incident angle on the microlens ML can suppress the influence of crosstalk. The crosstalk amount may be expressed as a ratio of the signal intensity of the first photoelectric converter PD1 to the signal intensity of the second photoelectric converter PD2.

Crosstalk includes at least one of optical crosstalk caused by stray light resulting from reflection or scattering in the microlens ML, a wiring layer, etc., and electrical crosstalk caused by the movement of electric charges to other adjacent photoelectric converters.

In this embodiment, the optical system 1 may satisfy the following inequalities (1) and (2) using the widths Sh1 and Sh2 and the focal length fb of the rear group LEB.

$$0.06 \leq \vert Sh 1 / fb \vert \leq 0.5 \qquad ( 1 )$$

$$0.06 \leq \vert Sh 2 / fb \vert \leq 0.5 \qquad ( 2 )$$

Satisfying inequalities (1) and (2) can properly set the incident angles of the first ray RYR and the second ray RYL incident on the microlens ML of the image sensor SN. In a case where the values become higher than the upper limits of inequalities (1) and (2), an effective diameter of the rear group LEB (a diameter on a lens surface of a ray passing through a position farthest from the optical axis OAB among rays passing through the rear group LEB) and finally the optical system 1 increase, and it becomes difficult to satisfactorily correct various aberrations. In a case where the values become lower than the lower limits of inequalities (1) and (2), the influence of crosstalk increases, an S/N ratio (signal-to-noise ratio) of each signal acquired by the first photoelectric converter PD1 and the second photoelectric converter PD2 reduces, and image quality may deteriorate.

Inequalities (1) and (2) may be replaced with inequalities (1a) and (2a) below:

$$0.07 \leq \vert Sh 1 / fb \vert \leq 0.45 \qquad ( 1 a )$$

$$0.07 \leq \vert Sh 2 / fb \vert \leq 0.45 \qquad ( 2 a )$$

Inequalities (1) and (2) may be replaced with inequalities (1b) and (2b) below:

$$0.08 \leq \vert Sh 1 / fb \vert \leq 0.39 \qquad ( 1 b )$$

$$0.08 \leq \vert Sh 2 / fb \vert \leq 0.39 \qquad ( 2 b )$$

The optical system 1 may satisfy the following inequality (3):

$$0.5 \leq ( \vert Sh 1 \vert + \vert Sh 2 \vert ) / f\_total ) \leq 7.0 \qquad ( 3 )$$

where f_total is a focal length of optical system 1 (having the configuration from the first front group LER to the rear group LEB).

In a case where the value becomes higher than the upper limit of inequality (3), the size of the optical system 1 increases and the optical path length is to be extended. Thus, it becomes difficult to correct aberrations, and the number of optical elements is to increase. In a case where the value becomes lower than the lower limit of inequality (3), sufficient parallax images for stereoscopic imaging cannot be obtained.

Inequality (3) may be replaced with inequality (3a) below:

$$0.6 \leq ( \vert Sh 1 \vert + \vert Sh 2 \vert ) / f\_total ) \leq 6.8 \qquad ( 3 a )$$

Inequality (3) may be replaced with inequality (3b) below:

$$0.7 \leq ( \vert Sh 1 \vert + \vert Sh 2 \vert ) / f\_total ) \leq 6.5 \qquad ( 3 b )$$

Now, PD1S and PD2S are signal intensities of the first photoelectric converter PD1 and the second photoelectric converter PD2, respectively, CT1 and CT2 are crosstalk amounts generated in the first photoelectric converter PD1 and the second photoelectric converter PD2, respectively, and PD1S′ and PD2S′ are corrected signal intensities corresponding to the first photoelectric converter PD1 and the second photoelectric converter PD2, respectively. Then, the following relationships hold:

$$PD 1 {S}^{′} = PD 1 S - PD 2 S \times CT 1 \qquad ( 4 a )$$

$$PD 2 {S}^{′} = PD 2 S - PD 1 S \times CT 2 \qquad ( 4 b )$$

Using equations (4a) and (4b), this embodiment can acquire correction signals that can suppress the influence of crosstalk generated between the photoelectric converters based on the signal intensities and crosstalk amounts of the first photoelectric converter PD1 and the second photoelectric converter PD2.

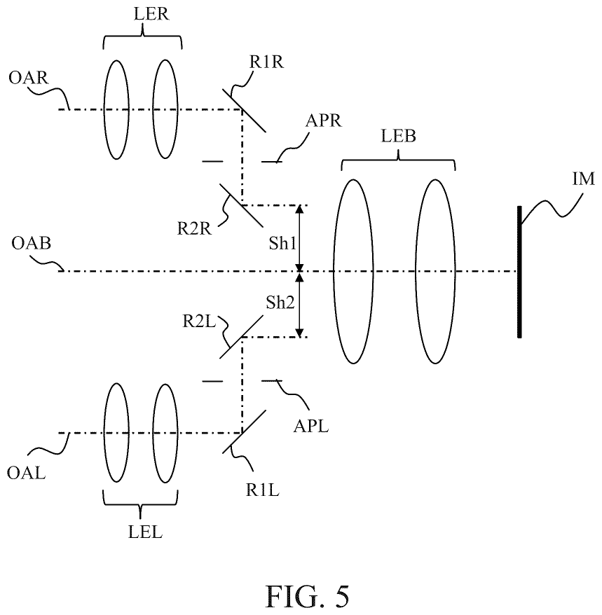

FIG. 5 illustrates a variation of the optical system 1. The optical system 1 includes first reflective surfaces R1R and R1L disposed on the optical paths from the first front groups LER and LEL to the rear group LEB. The optical system 1 further includes second reflective surfaces R2R and R2L disposed on the optical paths from the second front groups LER and LEL to the rear group LEB. This configuration can increase a distance between the optical axes OAR and OAL of the first front group LER and the second front group LEL and the base length. Thereby, this configuration can acquire a larger parallax for a stereoscopic image. The reflective surfaces R1R and R1L may be configured to totally reflect light, such as prisms. In FIG. 5, the optical path is bent in the vertical direction to the paper plane, but it may be bent in the depth direction to the paper plane.

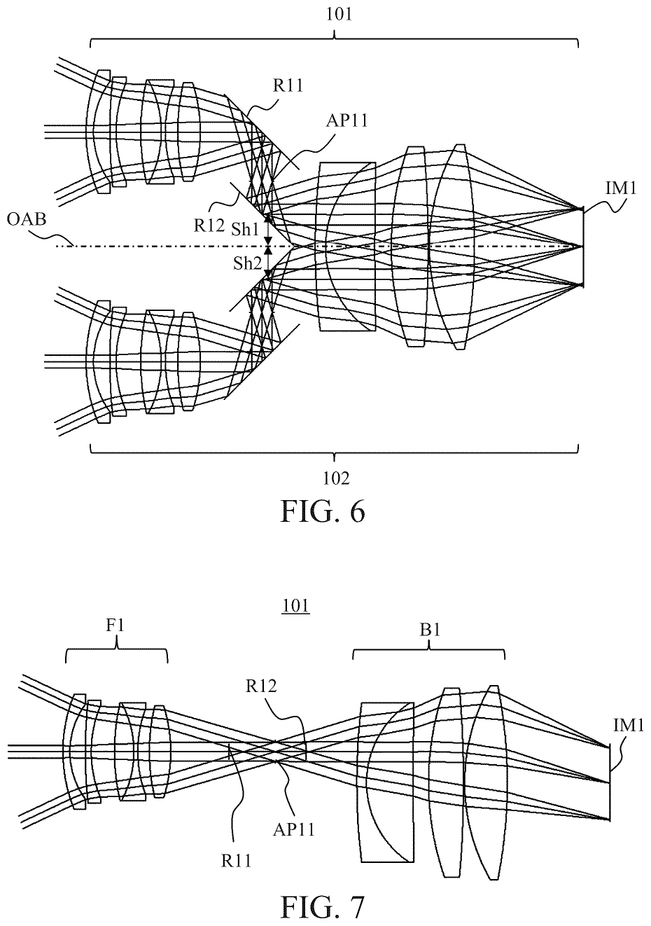

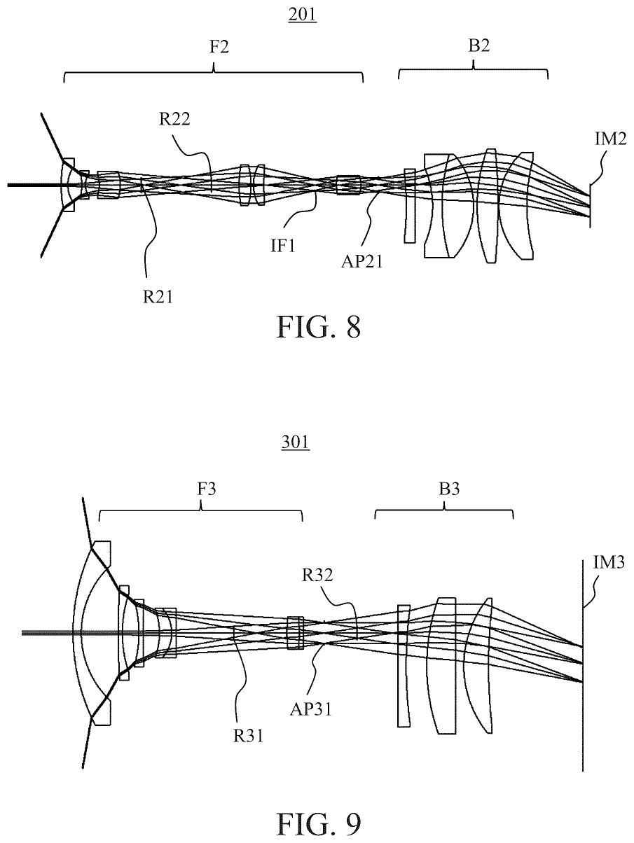

FIG. 6 illustrates an optical system according to Example 1. FIG. 7 illustrates a part of the optical system according to Example 1. FIG. 8 illustrates a part of an optical system according to Example 2. FIG. 9 illustrates a part of an optical system according to Example 3.

As illustrated in FIG. 6, the optical system according to Example 1 includes an optical unit 101 including a first front group and a rear group, and an optical unit 102 including a second front group and the rear group. The optical systems according to Examples 2 and 3 also include two optical units. FIGS. 7 to 9 illustrate the optical units 101, 201, and 301 including the first front group, respectively.

As illustrated in FIG. 7, the optical unit 101 includes a first front group F1, reflective surfaces R11 and R12 for bending the optical path, an aperture stop AP11, and a rear group B1. IM1 represents an image plane.

As illustrated in FIG. 8, the optical unit 201 includes a first front group F2, reflective surfaces R21 and R22 for bending the optical path, an aperture stop AP21, and a rear group B2. IM2 represents an image plane. IF1 represents an intermediate image formed by the first front group F2 in the optical path. In this example, the intermediate image IF1 is formed on the object side of the rear group LEB.

As illustrated in FIG. 9, the optical unit 301 includes a first front group F3, reflective surfaces R31 and R32 for bending the optical path, an aperture stop AP31, and a rear group B3. IM3 represents an image plane.

Numerical values corresponding to Examples 1 to 3 will be illustrated below. In each numerical example, R represents a radius of curvature of each optical surface. The radius of curvature R is positive when it is convex toward the intermediate image, and negative when it is concave toward the intermediate image. D represents a distance between m-th and (m+1)-th surfaces. The surface distance D is positive in a direction toward a reduction-side conjugate surface, and m is a surface number counted from the light incidence side. Nd represents the refractive index of each optical element with respect to the d-line, and vd represents the Abbe number of the optical element. The Abbe number vd of a certain material is expressed as follows:

$$vd = ( Nd - 1 ) / ( NF - NC )$$

where Nd, NF, and NC are refractive indices for the d-line (587.6 nm), F-line (486.1 nm), and C-line (656.3 nm) in the Fraunhofer line.

The optical surfaces in each of numerical examples 1 to 3 include rotationally symmetric spherical surfaces, but may include rotationally symmetric aspheric surfaces, anamorphic surfaces, and free-form surfaces, as necessary. A cover glass, dustproof glass, etc. may be placed on the optical path. A decentering system or bending system using a reflective surface may be used according to the apparatus layout.

### Numerical Example 1

| | Surf No. | R | D | Nd | νd |
|---|---|---|---|---|---|
| F1 | 1 | 39.22 | 1.80 | 1.713 | 53.9 |
| | 2 | 20.66 | 4.00 | 1.000 | |
| | 3 | 127.48 | 1.50 | 1.713 | 53.9 |
| | 4 | 30.66 | 6.00 | 1.000 | |
| | 5 | 55.80 | 5.00 | 1.667 | 48.3 |
| | 6 | −26.85 | 1.00 | 1.623 | 58.2 |
| | 7 | 31.17 | 3.00 | 1.000 | |
| | 8 | 50.91 | 5.50 | 1.620 | 36.3 |
| | 9 | −39.25 | 15.00 | 1.000 | |
| | R11 | ∞ | 12.00 | 1.000 | |
| | AP11 | ∞ | 8.00 | 1.000 | |
| | R12 | ∞ | 13.00 | 1.000 | |
| B1 | 13 | 171.22 | 2.50 | 1.805 | 25.4 |
| | 14 | 24.56 | 12.00 | 1.667 | 48.3 |
| | 15 | 942.11 | 4.00 | 1.000 | |
| | 16 | 74.06 | 9.00 | 1.743 | 49.4 |
| | 17 | −288.03 | 0.30 | 1.000 | |
| | 18 | 50.58 | 11.00 | 1.743 | 49.4 |
| | 19 | −128.13 | 26.50 | 1.000 | |
| | IM1 | ∞ | 0.00 | 1.000 | |

### Numerical Example 2

| | Surf No. | R | D | Nd | νd |
|---|---|---|---|---|---|
| F2 | 1 | 37.06 | 1.90 | 1.910 | 35.0 |
| | 2 | 8.52 | 4.00 | 1.000 | |
| | 3 | −12.63 | 1.00 | 1.531 | 55.9 |
| | 4 | 5.17 | 4.00 | 1.000 | |
| | 5 | −10.31 | 6.00 | 1.910 | 35.0 |
| | 6 | −10.93 | 6.00 | 1.000 | |
| | R21 | ∞ | 20.00 | 1.000 | |
| | R22 | ∞ | 8.00 | 1.000 | |
| | 9 | 36.28 | 3.40 | 1.531 | 55.9 |
| | 10 | −22.44 | 0.70 | 1.000 | |
| | 11 | 11.70 | 3.00 | 1.497 | 81.6 |
| | 12 | 73.63 | 0.70 | 1.000 | |
| | 13 | ∞ | 20.00 | 1.000 | |
| | 14 | 11.72 | 7.00 | 1.497 | 81.6 |
| | 15 | −7.97 | 5.00 | 1.000 | |
| | AP21 | ∞ | 8.00 | 1.000 | |
| B2 | 17 | −80.03 | 2.50 | 1.910 | 35.0 |
| | 18 | ∞ | 5.00 | 1.000 | |
| | 19 | −27.70 | 2.72 | 1.805 | 25.4 |
| | 20 | 55.00 | 9.00 | 1.667 | 48.3 |
| | 21 | −22.11 | 1.00 | 1.000 | |
| | 22 | 46.43 | 6.00 | 1.697 | 55.5 |
| | 23 | −177.48 | 0.27 | 1.000 | |
| | 24 | 21.07 | 8.00 | 1.743 | 49.4 |
| | 25 | 51.55 | 18.00 | 1.000 | |
| | IM2 | ∞ | 0.00 | 1.000 | |

### Numerical Example 3

| | Surf No. | R | D | Nd | νd |
|---|---|---|---|---|---|
| F3 | 1 | 34.46 | 1.40 | 1.713 | 53.9 |
| | 2 | 15.87 | 6.30 | | |
| | 3 | 140.00 | 0.70 | 1.713 | 53.9 |
| | 4 | 21.46 | 2.80 | | |
| | 5 | −21.46 | 0.70 | 1.713 | 53.9 |
| | 6 | 105.00 | 2.80 | | |
| | 7 | −12.16 | 2.10 | 1.623 | 58.2 |
| | 8 | −6.34 | 0.70 | 1.805 | 25.4 |
| | 9 | ∞ | 9.80 | | |
| | R31 | ∞ | 9.10 | | |
| | 11 | 27.93 | 2.10 | 1.847 | 23.8 |
| | 12 | −27.03 | 0.70 | 1.667 | 48.3 |
| | 13 | ∞ | 3.50 | | |
| | AP31 | ∞ | 5.60 | | |
| | R32 | ∞ | 7.00 | | |
| B3 | 16 | ∞ | 1.40 | 1.805 | 25.4 |
| | 17 | 77.07 | 3.50 | | |
| | 18 | 34.80 | 4.90 | 1.772 | 49.6 |
| | 19 | ∞ | 1.40 | | |
| | 20 | 18.23 | 4.20 | 1.772 | 49.6 |
| | 21 | 90.96 | 16.10 | | |
| | IM3 | ∞ | 0.00 | 1.000 | |

Table 1 summarizes values of inequalities (1), (2), and (3) in the optical units 101, 201, and 301 according to numerical examples 1 to 3.

TABLE 1

| | Example 1 | Example 2 | Example 3 |
|---|---|---|---|
| \|Sh1\| | 8.0 | 6.0 | 6.5 |
| \|Sh2\| | 8.0 | 6.0 | 2.0 |
| fb | 33.5 | 18.3 | 21.2 |
| \|Sh1\|/fb | 0.24 | 0.33 | 0.31 |
| \|Sh2\|/fb | 0.24 | 0.33 | 0.09 |
| \|Sh1\| + \|Sh2\| | 16.00 | 12.00 | 8.50 |
| f_total | 21.19 | 2.92 | 3.19 |
| \|Sh1\| + \|Sh2\|/f_total | 0.76 | 4.11 | 2.66 |

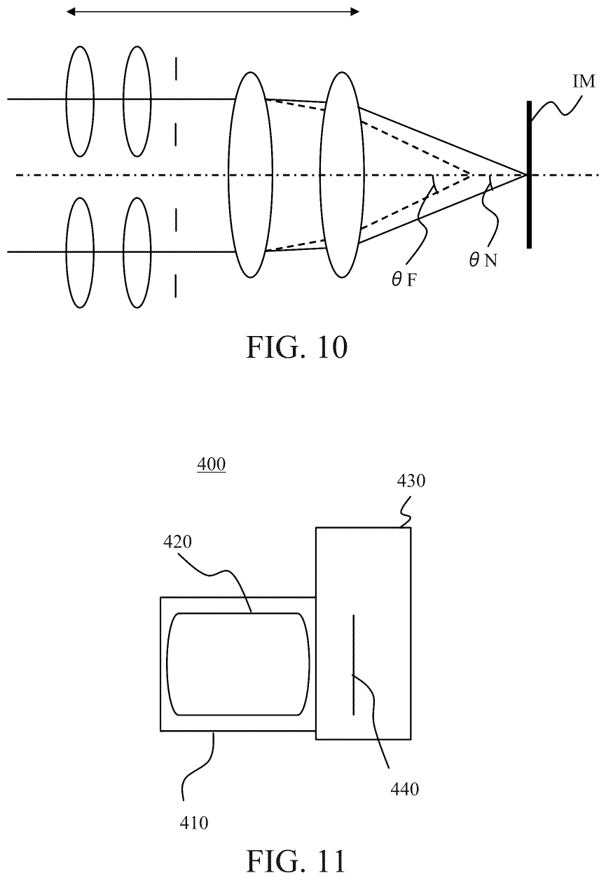

FIG. 10 illustrates image-plane position fluctuations of the optical system 1 caused by focusing or the like. In a case where the object plane is focused from a far distance to a close distance, an incident angle of a ray on the image plane IM changes from OF to ON. That is, the incident angle changes as a distance from the rear principal plane of the optical system 1 to the image plane IM changes. Hence, in equations (4a) and (4b), a change amount in the distance from the rear principal plane to the image plane IM caused by focusing may be considered. For example, the distance from the object plane and the change amount in the distance from the rear principal plane to the image plane IM caused when at least one or more optical elements constituting the optical system 1 are moved are previously recorded, and a change in the incident angle of the ray on the image plane IM can be estimated according to an actual moving amount. Therefore, the crosstalk amount can be switched according to the change in the incident angle of the ray incident on the image plane IM caused by focusing or the like. In FIG. 10, focusing is performed by moving all groups, but focusing may be performed by moving a part of the optical elements.

FIG. 11 illustrates an image pickup apparatus (digital still camera) 400 using the optical system 1 according to this embodiment as an imaging optical system 420. The image pickup apparatus 400 includes a camera 430 that includes an imaging unit 440 including the image sensor SN, and a lens apparatus (optical apparatus) 410 that includes the imaging optical system 420.

The lens apparatus 410 may be integrated with or attachable to and detachable from (detachably mountable to) the camera 430. The lens apparatus 410 may further include a communication unit communicable with the camera 430. The first photoelectric converter PD1 in the image sensor SN is configured to photoelectrically convert an image formed by light passing through the first aperture stop APR. The second photoelectric converter PD2 in the image sensor SN is configured to photoelectrically convert an image formed by light passing through the second aperture stop and the second aperture stop APL. In this case, the communication unit may transmit to the camera 430 information regarding the imaging optical system 420 that is used to correct signals from the first photoelectric converter and the second photoelectric converter. The information regarding the imaging optical system 420 includes information regarding a distance from the first ray RYR just before entering the rear group LEB to the optical axis OAB in the first direction perpendicular to the optical axis OAB in an in-focus state at infinity, a distance from the second ray RYL just before entering the rear group LEB to the optical axis OAB in the first direction in the in-focus state at infinity, and the focal length fb of the rear group LEB in the in-focus state at infinity. The information regarding the imaging optical system 420 may further include a change amount in a distance from the rear principal plane to the image plane IM caused by focusing in the in-focus state at infinity.

The image pickup apparatus 400 may further include a calculator (correction unit) configured to correct a signal from each photoelectric converter using equations (4a) and (4b) and the information regarding the imaging optical system 420 and calculate (acquire) the corrected signal intensity, and a memory storing a table of a crosstalk amount for each focus position. In this case, PD1S' and PD2S′ are signal intensities corrected by the correction unit and corresponding to the first photoelectric converter PD1 and the second photoelectric converter PD2, respectively. FIG. 11 illustrates a single optical system because two optical systems are arranged side by side in the depth direction. The image pickup apparatus 400 includes the imaging optical system 420 including the common rear group in a proper arrangement, and thus has a reduced size but can provide stereoscopic imaging and suppress deterioration of the image quality. The optical system 1 is not limited to a digital still camera, but is applicable to various image pickup apparatuses such as broadcasting cameras, film-based cameras, and surveillance cameras.

While the disclosure has described example embodiments, it is to be understood that the disclosure is not limited to the example embodiments. The scope of the following claims is to be accorded the broadest interpretation so as to encompass all such modifications and equivalent structures and functions.

This embodiment can provide an optical system that has a reduced size and can suppress degradation of the image quality.

This application claims priority to Japanese Patent Application No. 2024-037386, which was filed on Mar. 11, 2024, and which is hereby incorporated by reference herein in its entirety.

What is claimed is:

1. An optical system comprising:
a first front group and a second front group that are arranged in a first direction perpendicular to an optical axis direction;
a rear group that is commonly used for the first front group and the second front group;
a first aperture stop disposed between the first front group and the rear group; and
a second aperture stop disposed between the second front group and the rear group,
wherein a first principal ray passing through an aperture center in the first aperture stop and a second principal ray passing through an aperture center in the second aperture stop are guided to an intersection of an optical axis of the rear group and an image plane, and
wherein the following inequalities are satisfied:
$$0.06 \leq \vert Sh 1 / fb \vert \leq 0.5 \\ 0.06 \leq \vert Sh 2 / fb \vert \leq 0.5$$
where Sh1 is a distance in the first direction between the first principal ray just before entering the rear group and the optical axis of the rear group in an in-focus state at infinity, Sh2 is a distance in the first direction between the second principal ray just before entering the rear group and the optical axis of the rear group in the in-focus state at infinity, and fb is a focal length of the rear group in the in-focus state at infinity.

2. The optical system according to claim 1, wherein the first principal ray just before entering the rear group, the second principal ray just before entering the rear group, and the optical axis are parallel and non-coaxial with each other.

3. The optical system according to claim 1, wherein the rear group has positive refractive power.

4. The optical system according to claim 1, wherein the first front group and the second front group are optical systems having the same configurations.

5. The optical system according to claim 1, wherein the first aperture stop and the second aperture stop are disposed adjacent to and disposed on an object side of the rear group.

6. The optical system according to claim 1, wherein an intermediate image is formed in an optical path of the optical system.

7. The optical system according to claim 1, wherein an intermediate image is formed on an object side of the rear group.

8. The optical system according to claim 1, wherein a lens closest to an object in each of the first front group and the second front group is a negative lens.

9. The optical system according to claim 1, wherein a lens closest to an image plane in the optical system is a positive lens.

10. The optical system according to claim 1, further comprising an optical element configured to move during focusing.

11. The optical system according to claim 1, wherein the following inequality is satisfied:
$$0.5 \leq ( \vert Sh 1 \vert + \vert Sh 2 \vert ) / f\_total ) \leq 7.0$$
where f_total is a focal length of the optical system.

12. The optical system according to claim 1, wherein the following inequalities are satisfied:
$$0.06 \leq \vert Sh 1 / fb \vert \leq 0.24 \\ 0.06 \leq \vert Sh 2 / fb \vert \leq 0.24 .$$

13. An optical system comprising:
a first front group and a second front group that are arranged in a first direction perpendicular to an optical axis direction;
a rear group that is commonly used for the first front group and the second front group;
a first aperture stop disposed between the first front group and the rear group; and
a second aperture stop disposed between the second front group and the rear group,
wherein a first principal ray passing through an aperture center in the first aperture stop and a second principal ray passing through an aperture center in the second aperture stop are guided to an intersection of an optical axis of the rear group and an image plane.

14. An optical apparatus detachably mountable to an image pickup apparatus, the optical apparatus comprising:
the optical system according to claim 1; and
a communication unit communicable with the image pickup apparatus,
wherein the image pickup apparatus includes a first photoelectric converter and a second photoelectric converter, each of which is configured to photoelectrically convert an image formed by light passing through the first aperture stop and the second aperture stop, and
wherein the communication unit transmits to the image pickup apparatus information regarding the optical system that is used to correct signals from the first photoelectric converter and the second photoelectric converter.

15. The optical apparatus according to claim 14, wherein the information includes information regarding a distance from the first principal ray just before entering the rear group to the optical axis in the first direction in the in-focus state at infinity, a distance from the second principal ray just before entering the rear group to the optical axis in the first direction in the in-focus state at infinity, and a focal length of the rear group in the in-focus state at infinity.

16. The optical apparatus according to claim 14, further comprising an optical element configured to move during focusing.

17. The optical apparatus according to claim 16, wherein the information includes information regarding a distance from the first principal ray just before entering the rear group to the optical axis in the first direction in the in-focus state at infinity, a distance from the second principal ray just before entering the rear group to the optical axis in the first direction in the in-focus state at infinity, a focal length of the rear group in the in-focus state at infinity, and a change amount in a distance from a rear principal plane to the image plane caused by focusing in the in-focus state at infinity.

18. An image pickup apparatus detachably mounted with the optical apparatus according to claim 14, the image pickup apparatus comprising:
the first photoelectric converter; and
the second photoelectric converter.

19. The image pickup apparatus according to claim 18, further comprising a correction unit configured to correct the signals based on the information regarding the optical system.

20. The image pickup apparatus according to claim 19, wherein the following equations are satisfied:
$$PD 1 {S}^{′} = PD 1 S - PD 2 S \times CT 1 \\ PD 2 {S}^{′} = PD 2 S - PD 1 S \times CT 2$$
where PD1S is signal intensity of the first photoelectric converter, PD2S is signal intensity of the second photoelectric converter, CT1 is a crosstalk amount generated in the first photoelectric converter, CT2 is a crosstalk amount generated in the second photoelectric converter, PD1S′ is signal intensity corrected by the correction unit and corresponding to the first photoelectric converter, and PD2S′ is signal intensity corrected by the correction unit and corresponding to the second photoelectric converter.
